(19) United States
(12) Patent Application Publication
(10) Pub. No.: US 2022/0156773 A1
(43) Pub. Date: May 19, 2022

(54) DISPLAY DEVICE AND MONITORING DEVICE

(71) Applicant: Robert Bosch GmbH, Stuttgart (DE)

(72) Inventors: Jan Karl Warzelhan, Bad Salzdetfurth (DE); Sabine Gallian, Hoehenkirchen-Siegertsbrunn (DE)

(21) Appl. No.: 17/432,008

(22) PCT Filed: Feb. 5, 2020
(86) PCT No.: PCT/EP2020/052798

§ 371 Date: Aug. 18, 2021

(30) Foreign Application Priority Data
Feb. 18, 2019 (DE) 10 2019 202 104.2

(51) Int. Cl. G06Q 30/02; G06V 40/20; G06F 3/14; G06V 20/20

(52) U.S. Cl. CPC G06Q 30/0205; G06V 20/20; G06F 3/14; G06V 40/20

(57) ABSTRACT

A display device (9) for the in-situ analysis of a sales area (2), wherein the sales area (2) is monitored by means of an analysis device (7), the analysis device (7) is designed to analyse customer behaviour in the sales area (2) and provide same as analysis data, the display device (9) can be carried in the sales area (2) by a user (8), and comprising a position determination module (11) for determining an analysis position, wherein the analysis position forms a section of the sales area (2) and comprises surroundings of the display device (9). The inventions further comprises a data interface (10) for data coupling to the analysis device (7) and for receiving the analysis data, a display (4) for displaying display data, and a data generation module (13) which is designed to generate the display data for the analysis position, the display data comprising a subset of the analysis data.

### PRIOR BACKGROUND OF THE INVENTION

A display device for the in-situ analysis of a retail region, wherein the retail region is monitored by means of an analysis device, wherein the analysis device is configured to analyze a customer behavior and to provide same as analysis data, wherein the analysis data are able to be represented on a display unit.

The document DE 10 2008 001 126 A1, which probably forms the closest prior art, describes an inventory taking system and a video monitoring system. A warehouse or a retail region with products can be monitored by means of this invention, wherein position information and identification information of the detected product are ascertained during the monitoring and/or detection. In that case, an assignment unit is configured to model a spatial distribution of the products in the monitoring regions by way of the position information and the identification information from a plurality of detected products.

### SUMMARY OF THE INVENTION

A display device for the in-situ analysis of a retail region is proposed. A monitoring device is furthermore proposed.

The starting point of the invention is the fact that a large number of businesses and stores are monitored by way of video technology and/or product technology. The performance of the business is intended to be improved by means of the monitoring. To that end, use is made of analysis devices that can carry out in-store analytics, also called retail analysis. A customer behavior in retail trade or in retail business can be analyzed and evaluated by means of such analyses. The data obtained can be aggregated over time and/or else over positions and provided to a user, for example a retail business manager, an advertising department or data analysts. The analysis data can be provided by means of graphical output (dashboard) and/or on the basis of tables. On the basis of the analysis data, the user can then optimize the product arrangement, the shelving arrangement or other parameters such that the customer behavior is controlled as desired.

A display device for the in-situ analysis of a retail region is proposed. The display device is configured in particular for interactive display. By means of the display device, an analysis and/or a display can be effected in situ and/or at different regions in the retail region. A direction- and/or position-dependent display and/or analysis of the retail region is possible by means of the display device. In particular, the display device forms a smart terminal. In-situ analysis is understood to mean for example location-dependent analysis, evaluation and/or display of analysis data. The in-situ analysis can relate to a two-dimensional, three-dimensional or punctiform region of the retail region. Retail region is a store, a shopping center or a retail business, for example. The in-situ analysis preferably relates to products, product performance, customer flows and/or retail data.

The retail region is monitored by means of an analysis device and/or a monitoring device. The monitoring can be an optical analysis, a sensor-based analysis or an analysis dependent on product sales. By way of example, by means of the analysis device or a monitoring device, the retail region is optically monitored and the change of products, for example taking away and/or sales, is optically detected. Furthermore, the analysis device can be configured to detect, to evaluate and/or to analyze movement patterns, residence duration and/or customer behavior in the retail region. Examples of customer behavior include paths, taking away products, speeds and/or residence durations. Furthermore, with respect to the customer behavior, it is possible to create and/or analyze a metadata set comprising for example ethnic origin, dimensions, age, times of day and/or night. The customer data and/or the customer behavior are/is collected and/or provided as analysis data by the analysis device. The analysis data can be stored as a data set and/or as optical, video or acoustic data. The analysis data are created in particular for the entire retail region and/or broken down to partial regions of the retail region.

The display device is able to be carried in the retail region by a user. The display device forms for example a mobile device that is able to be transported by the user. The display device is configured as a smart device, for example. The display device can be configured in a pocket-size format. The weight of the display device is preferably less than 500 grams and specifically less than 300 grams. The display device is configured as a wireless device, for example. The display device is in particular a battery-operated display device.

The display device comprises a position determining module. The position determining module can be configured as a hardware module or a software module. By means of the position determining module, an analysis position is defined by the display device. The analysis position can be defined automatically by the position determining module on the basis of the position in the retail region; alternatively, the analysis position must be delimited and/or is delimited by an interaction between the user and the position determining module. The analysis position can form a two-dimensional, three-dimensional or punctiform section. The analysis position is comprised by the retail region and/or forms a section of the retail region. By way of example, the section of the retail region and/or the analysis position are/is a shelf, a sales area, a floor or a goods table. The analysis position forms in particular surroundings of the display device, wherein the surroundings are preferably arranged at a distance from the display device of less than five meters, specifically of less than three meters and specifically of less than one meter.

The display device comprises a data interface for data coupling to the analysis device. The data interface can form a virtual interface or a real interface. By way of example, a radio interface can be present as data interface. By means of the data interface, the display device can interrogate and receive analysis data or a portion of the analysis data and/or be provided by way thereof.

The display device comprises a display. The display can be configured as a color or black-and-white display. The display serves for displaying display data. The display can be configured for graphical, image, video and/or text display. The display data can comprise tables, images, heat maps and/or further data. By way of example, the display indication is configured as a display. Particularly preferably, the display is configured to enable a user interaction and/or to enable a data input by the user. By way of example, the display is configured as a touchscreen and/or touchpad.

The display device comprises a data generating module. The data generating module can be configured as a software module or as a hardware module. In particular, the analysis data are provided to the data generating module and/or the data generating module is configured to retrieve and/or to receive analysis data. The data generating module serves for generating, providing and/or compiling display data. The display data generated by the data generating module are the display data for the respective analysis position and/or for the position of the display device in the retail region. In this case, the data generating module is configured for example to select from the analysis data the data which are applicable, are meaningful and/or are present for the display position. The data generating module thus serves for example for a data reduction of the analysis data to form the display data for the respective display position and/or analysis position. The display data comprise a subset of the analysis data. The display data can comprise statistical data, tables, graphical display and/or images. The display data specifically comprise information, additional data and/or events for the analysis position. The display data generated by the data generating module are finally displayed by the display.

A consideration of the invention involves making possible an improved analysis of retail analyses of a retail region. In particular, a consideration involves making possible a better understanding of the sales and/or retail data of the retail region. An in-situ analysis is thus possible, in particular, such that the user can interpret and understand these data directly with reference to the surroundings in situ. It is thus possible, in contrast to previous practice, not to provide the analyses and data statistically on the computer and/or screen with a customary graphical user interface, but rather to enable this representation interactively in the store on the sales area and to be able to interpret the data. Therefore, the user can for example directly take notice of the analysis data and thus resort products, understand interactions of customers, rearrange presenters and/or goods tables that influence the path of customers, and/or improve the retail performance in some other way.

Optionally, provision is made for the display data to comprise a customer behavior, a number of customers, a number of interactions, in particular with a product, shelf or presenter, a heat map of the customer flows, a flow direction of the customer and/or the customers and/or a residence duration of the customer and/or the customers in relation to the analysis position. By way of example, the display data comprise information regarding how many customers there are on average at the analysis position and/or in the surroundings, how long they stay there and/or what products they select. In particular, this can encompass how these data develop further, for example what product is chosen by a customer who previously selected a different product. The flow direction can be displayed for example for an individual customer or for the average customers, wherein the display data comprise for example percentage flow directions and/or volumetric flows.

It is particularly preferred for the display device to comprise a camera unit. The camera unit is configured for example as a color, black-and-white or infrared camera. The camera unit is used for optical recording, in particular image or video recording, of a recording section. For this purpose, the display device, for example with the camera unit, can be directed at the recording section to be recorded. The recording section forms a partial region of the retail region. By way of example, for this purpose, the camera unit is directed at a shelf or a retail section, said shelf and/or said retail section being optically recorded as an image and/or video. The position determining module is configured to define the recording section as analysis position. By way of example, the position determining module is configured to correlate the recorded recording section and to recognize what position in the retail region corresponds and/or is to be assigned thereto. This configuration is based on the consideration that the user can select the recording section and/or the analysis position simply by means of the camera unit, without knowing how the analysis position is defined and/or is to be set in the analysis data, in a 3D model or in terms of coordinate technology.

In particular, provision is made for the camera unit to be configured for optically recording a recording section and/or for this image or this recording to be displayable on the display. By means of the display, it is possible for the user in particular to select a product, a location in the recording section, a shelf or a section. The selection of the product, the section and/or the shelf is effected for example graphically, specifically by drawing in an area and/or a polygon. In particular, the selection is effected by means of the touchscreen of the display. The position determining module is configured to define the selected product, the selected section and/or the selected shelf as analysis position. This configuration is based on the consideration of providing a display device in which a retail analysis at the product level, shelf level or section level is possible in situ. In particular, it is thus possible to analyze a product interaction, for example by selection of the corresponding product.

Preferably, the display device comprises a fusion module configured for example as a software module or hardware module. The fusion module is configured to generate an augmented reality image from the optical recording of the recording section and the display data. The augmented reality image is prepared for representing augmented reality. In this case, for example, the optical recording, in particular the image, is superimposed and/or fused with the display data. Preferably, the display data and/or the analysis data are superimposed and/or fused with the optical recording positionally correctly and/or locationally correctly. The display is configured to display the augmented reality image. In this case, the display device forms an augmented reality display, for example. This configuration is based on the consideration of inserting the desired analysis data and/or the display data into the optical recording and/or the current surroundings at the correct position.

One configuration of the invention provides for a filter criterion to be definable and/or selectable by the user. By way of example, the filter criterion is selectable by means of the display, configured for example as a touchscreen. The filter criterion is employed by the data generating module to generate, to filter and/or to adapt the display data for the analysis position. By way of example, the filter criteria are selectable in a selection menu. The filter criteria can be object-, customer-, position- and/or product-describing and/or -dependent. Examples of filter criteria are for example target groups, ethnic origin, product preferences, age groups and/or customer paths. By way of example, seniors can be set as filter criterion, wherein the display data are generated by the data generating module such that for the analysis position analysis data in relation to the seniors are displayed and analysis data relating to young persons and/or children are filtered out.

Specifically, provision is made for a time interval to be definable by the user. In particular, the time interval can also be understood as a filter criterion. The time interval can be a time period, but also a point in time. The data generating module is configured to generate, to filter and/or to aggregate the display data for the analysis position in relation to the time interval. By way of example, the time of day from 18:00 to 20:00 hours can be set as time interval, such that the analysis data from 18:00 to 20:00 hours are used for the display data. In particular, provision can also be made to generate the analysis data for the display data for a time interval of the last two weeks in the case where the time interval is selected as two weeks. This configuration is based on the consideration of having a simple possibility for enabling an improved and/or more meaningful in-situ analysis.

Optionally, provision is made for the display data to comprise a navigation direction. The navigation direction describes for example the—on a statistical analysis of the analysis device—most probable further customer flow, a percentage customer flow and/or the direction of movement of a selected customer. The navigation direction can be displayed as an arrow, for example. In particular, it is possible when displaying the percentage customer flow, for example, to display the possible navigation directions as arrows with percentage figures. Specifically, it can be provided that something is selected as filter criterion and the customer flow is displayed in relation to the filter criterion and/or that a product was selected and the customer flow is displayed for customers who bought the product.

Specifically, provision is made for the display data to comprise a customer path. The customer path serves for tracing a path of a customer, in particular of a selected customer, of a customer group and/or of a customer who has previously bought something specific. The customer path makes it possible to trace and/or track this customer's path through the retail region. This configuration is based on the consideration of providing a display device which enables a customer journey. By way of example, for this purpose, the user selects a customer and/or a customer group and is then guided and/or led by means of navigation directions and/or navigation displays such that the user tracks the customer's path through the retail region. A specific customer journey and/or a specific customer path can be traced and/or selected for a thief, for example. By way of example, it is known that a person constitutes a thief, and so the thief's path through the retail region is subsequently traceable. These data can be used either to still catch the thief, and/or to implement structural measures making it possible for the thief to find escape more difficult in the future.

Optionally, the display data comprise customer information concerning a current person in the surroundings of the analysis position and/or in the surroundings of the display device. By way of example, the customer information can comprise data regarding whether the customer appears to be searching for something, probable product interests, offers of assistance and/or other customer-relevant data. In this case, the display device is configured to display these display data in particular without being noticed by the customer and/or inconspicuously. By way of example, by means of the display device, employees can thus be instructed to assist a customer in the surroundings and/or to offer said customer something.

In particular, the position determining module is configured to determine the position information and/or the display position by means of GPS locating, a position sensor, an acceleration sensor, an optical sensor and/or a beacon-based localizing system. In particular, the position determining module can be configured to use different sensors for position determination simultaneously and/or alternatively.

It is particularly preferred for the display device to constitute spectacles, a watch or a cellular phone and/or to be comprised thereby. By way of example, the display device is configured as spectacles, wherein the display data are projected onto the inner side of the spectacles, the spectacle lens, and/or are displayed there. By way of example, the display device can also constitute a watch, for example a smartwatch, and the display data can be displayed on the watch and/or the display of the watch. Alternatively, the display device can be configured as a smartphone or as a tablet.

The invention further relates to a monitoring device for the retail region. The monitoring device comprises an analysis device and at least one display device as described above. The analysis device comprises a camera for monitoring the retail region and/or comprises other sensors for retail analysis and/or monitoring of the retail region. The analysis device is couplable and/or coupled to the display device in terms of data technology. The display device can retrieve a subset and/or all of the analysis data from the analysis device. The display device is movable and/or portable independently of the analysis device in the retail region.

### BRIEF DESCRIPTION OF THE DRAWINGS

Further advantages and/or effects are evident from the accompanying figures and the description thereof. Here in the figures:

FIG. 1 schematically shows a store with retail region;

FIG. 2 schematically shows a display device as one exemplary embodiment;

FIGS. 3a and 3b show a further exemplary embodiment of a display device;

FIGS. 4a and 4b show a further exemplary embodiment of the display device.

### DETAILED DESCRIPTION

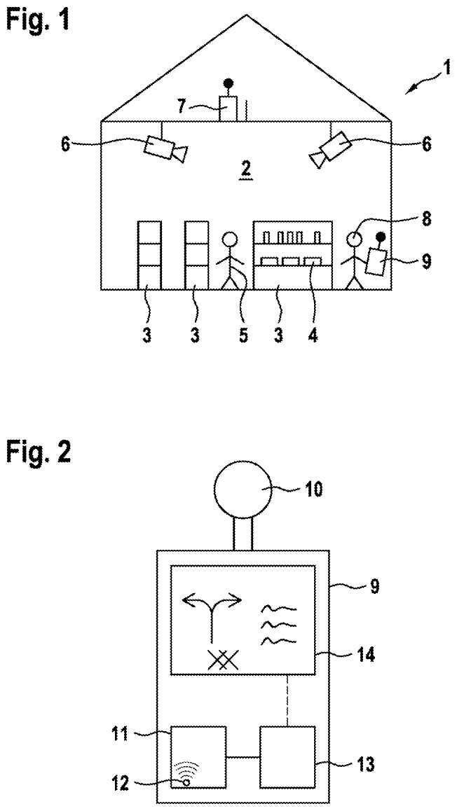

FIG. 1 schematically shows a store 1. The store 1 is configured for example as a department store and/or as a shopping mall. The store 1 has a retail region 2. The retail region 2 is an interior space. A plurality of shelves 3 are arranged in the retail region 2. Products 4 are offered for sale on the shelves 3. The shelves 3 and the product arrangement predefine a network of paths in the retail region 2 on which a customer 5 can move. The customer 5 interacts with the shelves 3 and the products 4. The customer 5 selects products 4, takes them away and traverses a customer path in the retail region 2. The movement of the customer 5, the buying behavior and additional information are monitored by a monitoring device. The monitoring device and/or the store 1 comprise(s) a plurality of cameras 6 configured to optically monitor the retail region 2. The cameras 6 track and/or capture the customer 5 in the retail region 2. Furthermore, the presence, removal and/or resorting of products and/or shelves 3 can be traced and analyzed by means of the cameras 6. The optical recording by means of the cameras 6 is provided to an analysis device 7 as image and/or video data. The analysis device 7 is configured to analyze, to monitor and/or to store the behavior of the customer 5, the product performance of products and/or further information in relation to the retail region 2. By way of example, the analysis device is configured to determine for products a number of purchases, a number of interactions with the customer 5 and/or to determine what product a customer 5 obtains after the purchase of the previous product. The analysis data are determined by the analysis device for the entire retail region 2 and/or for a partial region. The analysis data are able in particular to be broken down to product and/or shelf, or to the customer level.

A user 8 would then like to carry out the product and/or retail analysis in situ in order to look at the conditions in situ together with the analysis data. To that end, the user 8 has a display device 9. The display device 9 is configured as a mobile device and/or as a portable terminal. By way of example, the display device 9 constitutes a smartphone or a tablet. By means of the display device 9, the user 8 can cause display data to be displayed for the respective region where said user is situated and/or to which said user directs the display device. The display data displayed are a subset of the analysis data and in particular the subset of the analysis data representing and/or describing the product, the shelf or the respective section of the retail region.

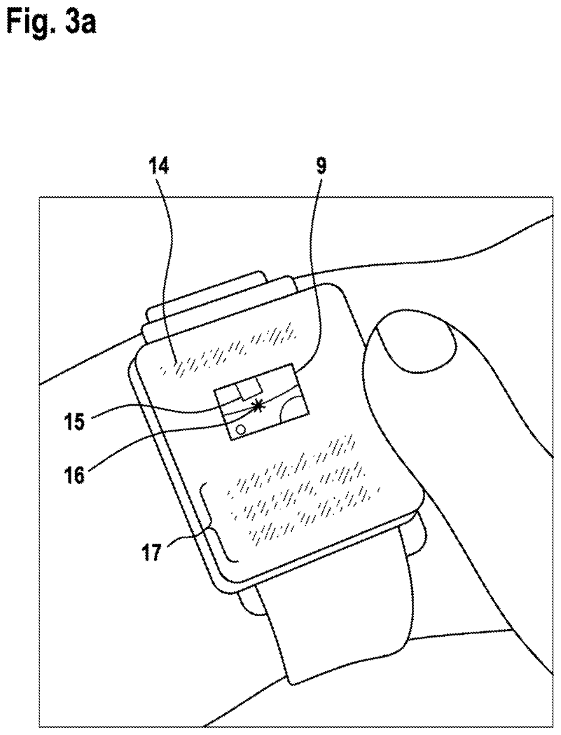

FIG. 2 schematically shows the display device 9 configured as a smartphone. The display device 9 comprises a data interface 10 for coupling to the analysis device 7. Via the interface 10, the display device 9 can obtain and/or interrogate a subset and/or all of the analysis data from the analysis device 7.

The display device 9 comprises a position determining module 11. The position determining module 11 comprises a position and/or location sensor 12, which can determine a position in the retail region. On the basis of the position in the retail region and/or a user selection in image data, the position determining module 11 is configured to define an analysis position. By way of example, the current position is defined as analysis position; alternatively, the user 8 can record an image of the surroundings in the retail region and select therein a section which said user would like to have defined as analysis position. In this case, the analysis position can be a two-dimensional region, a product or a spatial point.

The display device 9 comprises a data generating module 13. The analysis position is provided to the data generating module 13. The data generating module 13 is configured to provide display data for the analysis position and/or surroundings of the analysis position. In this case, the display data are data that can be used by the user 8 in order to be able to carry out a retail analysis of the analysis position. By way of example, for this purpose, the data generating module 13 selects a subset of the analysis data, in particular those data representing the surroundings and/or the retail behavior. The data generating module 13 is configured to provide these data as display data. The display data can comprise a tabular compilation, image data and/or other data sets.

The display device 9 comprises a display 14. The display 14 is configured for example as a display and specifically as a touchpad, such that a data input by the user 8 can also be effected by means of the display 14. The display data are provided to the display 14, wherein the display 14 displays the display data. By way of the display of the display data, the user 8 can then carry out a retail analysis directly in situ in the retail region.

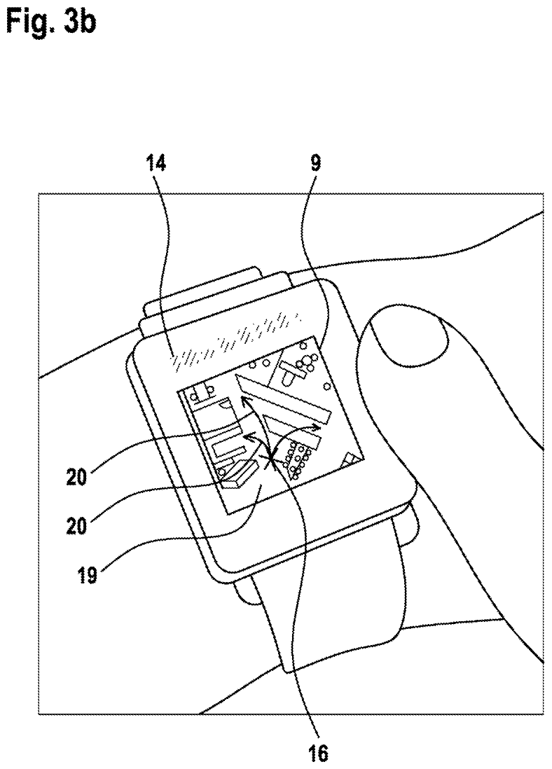

FIG. 3a shows a further exemplary embodiment of the display device 9. The display device 9 is configured here as a watch, in particular as a smartwatch. The display device 9 again has a display 14. The display 14 is configured for graphical and text display. Via the display 14, the user 8 can interact with the display device 9 and/or define data, such as filters, for example. The display device 9 further has rotary buttons and pushbuttons on the sides, such that the user 8 can interact with the display device 9 and input data via the pushbuttons and rotary buttons as well.

In this case, the display device 9 displays a map of the surroundings of the analysis position on the display 14. Said map is configured as a heat map 15. In particular, the current position 16 is displayed in the heat map 15. The heat map 15 symbolizes and/or indicates to the user 8 how the customer density is configured on average in this region.

Furthermore, the display device 9 is configured to display additional data 17. The additional data 17 are configured here as text format. The additional data 17 are part of the display data. The additional data 17 here describe an average duration for which a customer stays in this region, a number of customers in this region and an absolute number of customers in the retail region.

FIG. 3b shows the exemplary embodiment from FIG. 3a, wherein here other data and/or additional data are displayed on the display 14. A map 19 of the retail region is displayed again in this case. The current position 16 is drawn in said map 19, navigation directions 20 additionally being displayed, which indicate the direction in which on average the customer then continues to move. Consequently, on the basis of these data, the user 8 can estimate and/or interpret what further path said user ought to take and/or what further path is taken on average by customers.

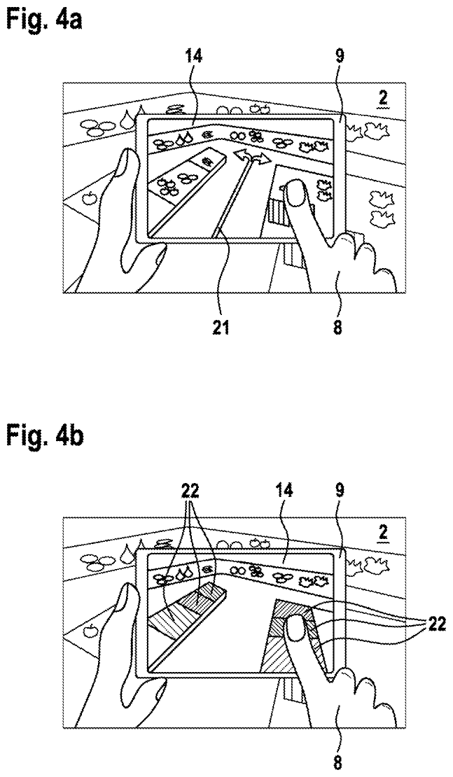

FIG. 4a shows a further exemplary embodiment of the display device 9. In this case, the display device 9 is configured as a tablet and has a rear-side camera for recording a section of the retail region 2. The recording of the retail region 2 by the camera is displayed on the display 14. In this case, the displayed image is superimposed with the display data 21, configured here as navigation symbols. The navigation symbols 21 are represented as arrows, additionally comprising a percentage proportion of the customer flows. The navigation symbol 21 is displayed in the image as an augmented reality image, such that the display device 9 is configured for displaying augmented reality. The user 22 can input and/or select data by means of the display 14, such that the display device 9 is controllable in this way.

FIG. 4b shows the display device 9 from FIG. 4a, wherein the user 8 has selected selection sections 22 in the image on the display. The selection sections 22 are selected for example by tapping, by marking areas and/or contours. The analysis region can thus be limited and/or defined, such that instead of the entire displayed section of the retail region 2, for example, the selected selection regions 22 serve as analysis positions. The data generating module is then configured to generate the display data for the selection regions 22.

1. A display device (9) for the in-situ analysis of a retail region (2),
wherein the retail region (2) is monitored by means of an analysis device (7), wherein the analysis device (7) is configured to analyze customer behavior in the retail region (2) and to provide same as analysis data,
wherein the display device (9) is able to be carried in the retail region (2) by a user (8), comprising a position determining module (11) for defining an analysis position, wherein the analysis position forms a section of the retail region (2), and comprises surroundings of the display device (9),
comprising a data interface (10) for data coupling to the analysis device (7) and for receiving the analysis data,
comprising a display (14) for displaying display data,
comprising a data generating module (13), wherein the data generating module (13) is configured to generate the display data for the analysis position, wherein the display data comprise a subset of the analysis data.

2. The display device (9) as claimed in claim 1, wherein the display data comprise a customer behavior, a number of customers, a number of interactions, a heat map (15) of the customer flows, a flow direction and/or a residence duration in relation to the analysis position.

3. The display device (9) as claimed in claim 1, further comprising a camera unit for optically recording a recording section, wherein the recording section forms a partial region of the retail region (2), wherein the position determining module (11) is configured to define the recording section as analysis position.

4. The display device as claimed in claim 1, further comprising by a camera unit for optically recording a recording section, wherein the recording section forms a partial region of the retail region (2) with products (4), wherein a product (4) is selectable by the user (8) by means of the display (14), wherein the position determining module (11) is configured to define the selected product (4) and/or the section of the selected product (4) as analysis position.

5. The display device (9) as claimed in claim 3, further comprising a fusion module, wherein the fusion module is configured to generate an augmented reality image from the optical recording of the recording section and the display data, wherein the display (14) is configured to display the augmented reality image.

6. The display device (9) as claimed in claim 1, wherein a filter criterion is definable by a user (8), wherein the data generating module (13) is configured to generate the display data on the basis of the filter criterion for the analysis position.

7. The display device (9) as claimed in claim 1, wherein a time interval is definable by a user (8), wherein the data generating module (13) is configured to generate the display data in relation to the time interval for the analysis position.

8. The display device (9) as claimed in claim 1, wherein the display data comprise a navigation direction (20), wherein the navigation direction (20) describes the most probable customer flow and/or a percentage customer flow.

9. The display device (9) as claimed in claim 1, wherein the display data comprise a customer path for tracing a path of a customer (5) through the retail region (2).

10. The display device (9) as claimed in claim 1, wherein the display data comprise customer information concerning a current person in the surroundings of the analysis position.

11. The display device (9) as claimed in claim 1, wherein the position determining module (11) is configured to determine position information by means of GPS, a position sensor, an acceleration sensor and/or a beacon-based localizing system.

12. The display device (9) as claimed in claim 1, wherein the display device (9) constitutes spectacles or a watch.

13. A monitoring device for a retail region (2) comprising an analysis device (7) and a display device (9) as claimed in claim 1.
